(19) United States
(12) Patent Application Publication
(10) Pub. No.: US 2009/0152767 A1
(43) Pub. Date: Jun. 18, 2009

(54) Method of manufacturing radiator grill for vehicle

(75) Inventors: Ho Tak Jeon, Gyeonggi-do (KR); Yong Chul Lee, Gyeongsangbuk-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR); ECOPLASTIC CORPORATION, Gyeongsangbuk-do (KR)

(21) Appl. No.: 12/229,175

(22) Filed: Aug. 19, 2008

(30) Foreign Application Priority Data
Dec. 13, 2007 (KR) 10-2007-0129815

(51) Int. Cl. B29C 45/00

(52) U.S. Cl. 264/241

(57) ABSTRACT

The present invention provides a method of manufacturing a radiator grill for a vehicle using a glossy metal film and acrylonitrile styrene acrylate (ASA) resin having excellent weatherability by a film insert molding process.

Accordingly, the present invention eliminates an existing plating process that is applied also to unnecessary portion so as to reduce manufacturing cost, simplify the process, shorten the process cycle, thus improving the productivity.

Moreover, the present invention eliminates a black coating process by using the ASA resin having excellent weatherability instead of conventionally used acrylonitrile butadiene styrene (ABS) resin and then by performing an embossing process.

### CROSS-REFERENCE TO RELATED APPLICATION

This application claims under 35 U.S.C. §119(a) the benefit of Korean Patent Application No. 10-2007-00129815 filed Dec. 13, 2007, the entire contents of which are incorporated herein by reference.

### BACKGROUND

(a) Technical Field

The present invention relates to a method of manufacturing a radiator grill for a vehicle. More particularly, the present invention relates to a method of manufacturing a radiator grill for a vehicle using a glossy metal film and acrylonitrile styrene acrylate (ASA) resin having excellent weatherability by a film insert molding process.

(b) Background Art

Generally, a radiator grill is a device that serves as a ventilating opening through which air required for cooling a radiator is introduced to the radiator. The radiator grill is provided in front of the radiator in a lattice form and may also be called a front mask as it includes front end components such as headlamps.

Recently, the size of the radiator grill has become smaller to reduce air resistance and, in certain cases, the radiator grill has elimina ted; however, the appearance of the radiator grill is one of the main factors that determines the overall appearance of the vehicle.

FIG. 3 is a process diagram showing an exemplary process of manufacturing a conventional radiator grill for a vehicle.

As shown in FIG. 3, the conventional radiator grill is manufactured in such a manner that an injection molded part is formed of acrylonitrile butadiene styrene (ABS) resin by an injection molding process. In the process shown, the injection molded part is subjected to a plating process to provide a glossy appearance on the surface, and a portion of the plated injection molded part is masked and then coated with black paint.

However, in manufacturing a radiator grill it can be difficult to plate only a specific region. Thus, because of certain difficulties of the plating process, the overall surface of the radiator grill is unnecessarily plated, which increases-manufacturing cost.

Further, when the black coated surface is chipped by gravel or sand during vehicle driving, the coated layer is peeled off to expose the plated layer, thus detracting from the appearance of the radiator grill.

Even further, since it takes about four hours to perform the existing plating process, which includes about 25 process steps in general, the overall process cycle is substantially lengthened, thus lowering productivity.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention is directed to a method of manufacturing a radiator grill for a vehicle, which eliminates a plating process and a black coating process and instead preferably applies a film insert molding process in which a glossy metal film is inserted into a mold and then a resin having excellent weatherability that is injection molded on the resin is applied.

In one embodiment, the present invention provides a method of manufacturing a radiator grill for a vehicle, the method comprising molding a metal film into a desired shape; trimming the molded metal film to fit a mold; inserting the trimmed metal film into the inside of the mold; and supplying a resin to the inside of the mold to be injected on one side of the metal film.

In another preferred embodiment, the method further comprises embossing the injection molded resin.

In another preferred embodiment, the resin is preferably acrylonitrile styrene acrylate (ASA) resin.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be-apparent from or are set forth in more detail in the accompanying drawings, which are incorporated in and form a part of this specification, and the following Detailed Description, which together serve to explain by way of example the principles of the present invention

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 is a process diagram schematically showing a process of manufacturing a radiator grill for a vehicle in accordance with a preferred embodiment of the present invention.

FIG. 2 is a flowchart showing a method of manufacturing a radiator grill for a vehicle in accordance with the present invention.

FIG. 3 is a process diagram showing a process of manufacturing a conventional radiator grill for a vehicle.

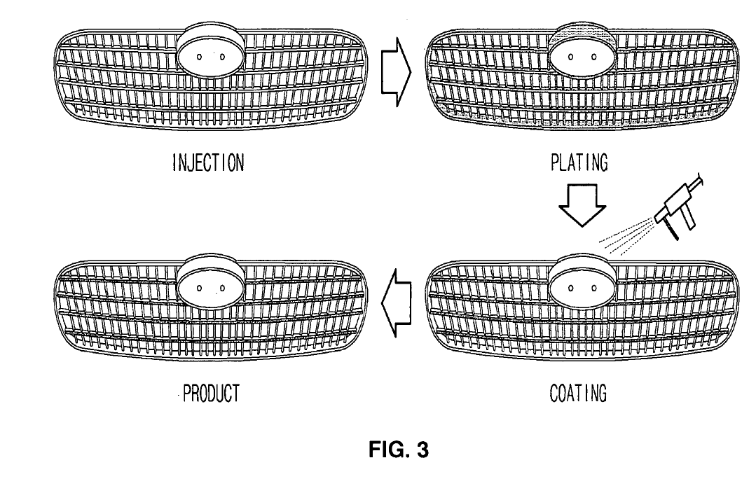

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes a method of manufacturing a radiator grill for a vehicle, the method comprising molding a metal film into a desired shape, trimming the molded metal film to fit a mold, inserting the trimmed metal film into the inside of the mold; and supplying a resin to the inside of the mold. In certain embodiments of the invention, the resin on the inside of the mold is injected on one side of the metal film. In other embodiments, the method as described herein further comprises embossing the injection molded resin. In other preferred embodiments of the invention, the resin is acrylonitrile styrene acrylate (ASA) resin.

In invention also encompasses a vehicle comprising a radiator grill as described herein.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. The invention is intended to cover not only the exemplary embodiments, but also various alternatives, modifications, equivalents and other embodiments, which may be included within the spirit and scope of the invention as defined by the appended claims.

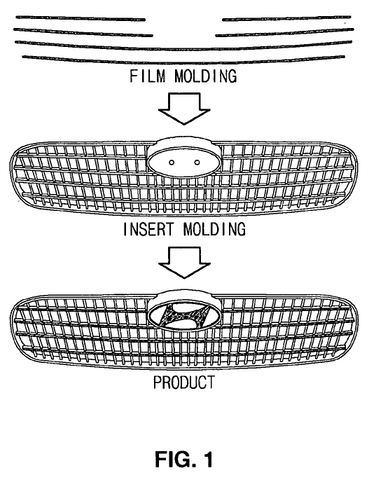

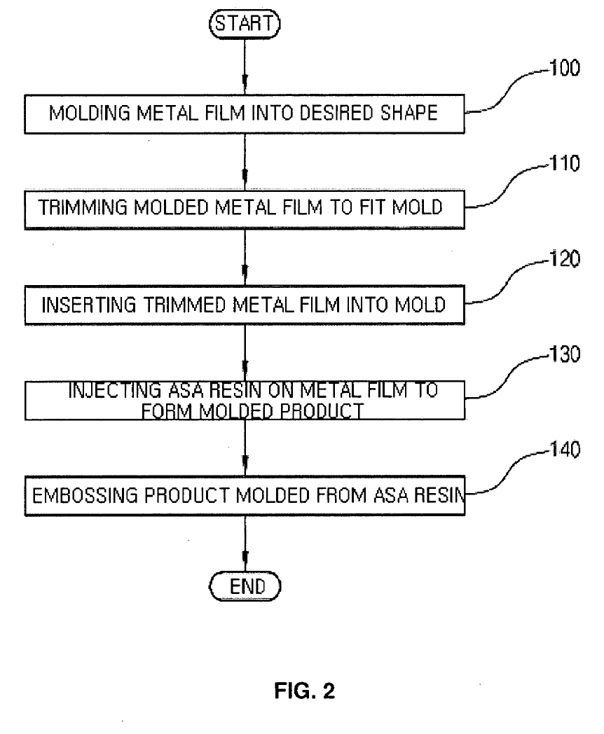

FIG. 1 is an exemplary process diagram schematically showing a process of manufacturing a radiator grill for a vehicle in accordance with a preferred embodiment of the present invention, and FIG. 2 is a flowchart showing an exemplary method of manufacturing a radiator grill for a vehicle in accordance with certain preferred embodiments of the present invention.

According to a preferred method of manufacturing a radiator grill for a vehicle in accordance with the certain embodiments of the present invention, the radiator grill is manufactured in such a manner that a suitable glossy metal film, which gives an impression of a high polished metal material, is molded into a desired shape, and a resin preferably having excellent weatherability is injection molded on one side of the molded metal film.

In exemplary embodiments, according to preferred manufacturing methods of the present invention, a suitable glossy metal film on which a metal film is deposited is molded into a desired shape to provide a glossy effect to the radiator grill as shown in the right image of FIG. 1 (S100).

In preferred examples, since a portion of the front surface of the radiator grill for a vehicle is formed into a glossy surface, the glossy metal film is suitably molded as shown in the left image of FIG. 1 by, for example, press molding or vacuum molding and thus applied to an area of the radiator grill that requires a suitably glossy effect (S100).

Next, the molded metal film is trimmed to fit a mold (S110) and the trimmed metal film is suitably inserted into the mold (S120).

Then, in further embodiments, a resin is supplied to the inside of the mold to be injected on one side of the trimmed metal film, thus forming a radiator grill (S130).

In preferred embodiments, in order to eliminate a black coating process performed to improve the weatherability of the radiator grill in the existing manufacturing process, the resin used may be, but is not limited to, acrylonitrile styrene acrylate (ASA) resin having excellent weatherability.

In certain exemplary embodiments, since the product molded from the ASA resin has a very low surface gloss, the product molded from the ASA resin is suitably subjected to an embossing process to lower the surface gloss (S140).

Since the above-described manufacturing method can preferably substitute the existing plating process with a film insert molding process by suitably applying the glossy metal film, it is possible to eliminate the plate process that is applied also to unnecessary portions.

Moreover, since the ASA resin having excellent weatherability is preferably applied instead of conventionally used acrylonitrile butadiene styrene (ABS) resin and the embossing process is applied thereto, it is possible to eliminate the black coating process.

In case of the conventional radiator grill, the black coated surface of the radiator grill may be chipped and damaged by gravel or sand bounced from the rear of a preceding vehicle to expose the chrome layer plated on the inside of the black paint, thus deteriorating the appearance of the radiator grill; however, the present invention can remove the source of such a chipping problem.

As described in the examples above, the method of manufacturing a radiator grill for a vehicle in accordance with the present invention has the following effects.

In exemplary embodiments, the plating process that is applied also to the unnecessary portions is eliminated, and thus the manufacturing cost is reduced.

In other exemplary embodiments, since the plating process that lengthens the overall process cycle is eliminated, the process is suitably simplified and the process cycle is shortened, thus improving the productivity.

In further embodiments, using the method of the invention as described herein, it is possible to eliminate the black coating process by using, for example, the ASA resin having excellent weatherability instead of the conventionally used ABS resin and then by performing the embossing process.

Accordingly, by performing the methods of the invention as described herein, it is possible to remove the source of the chipping problem, and thus the quality of the radiator grill is improved.

Moreover, with the elimination of the plating process as described herein, the manufacturing method in accordance with the present invention can provide an alternative process to the restrictions on the use of hexavalent chrome.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A method of manufacturing a radiator grill for a vehicle, the method comprising:
molding a metal film into a desired shape;
trimming the molded metal film to fit a mold;
inserting the trimmed metal film into the inside of the mold; and
supplying a resin to the inside of the mold to be injected on one side of the metal film.

2. The method of claim 1, further comprising embossing the injection molded resin.

3. The method of claim, wherein the resin is acrylonitrile styrene acrylate (ASA) resin.

4. A method of manufacturing a radiator grill for a vehicle, the method comprising:
molding a metal film into a desired shape;
trimming the molded metal film to fit a mold;
inserting the trimmed metal film into the inside of the mold; and
supplying a resin to the inside of the mold.

5. The method of claim 4, wherein the resin on the inside of the mold is injected on one side of the metal film.

6. The method of claim 4, further comprising embossing the injection molded resin.

7. The method of claim 4, wherein the resin is acrylonitrile styrene acrylate (ASA) resin.

8. The method of claim 2, wherein the resin is acrylonitrile styrene acrylate (ASA) resin.
